(19) United States
(12) Patent Application Publication
(10) Pub. No.: US 2026/0320391 A1
(43) Pub. Date: Oct. 15, 2026

(54) MODEL TRAINING METHOD AND COMMUNICATION APPARATUS

(71) Applicant: HUAWEI TECHNOLOGIES CO., LTD., Shenzhen (CN)

(72) Inventors: Gongzheng Zhang, Hangzhou (CN); Jian Wang, Hangzhou (CN); Rong Li, Shanghai (CN); Chen Xu, Hangzhou (CN)

(73) Assignee: HUAWEI TECHNOLOGIES CO., LTD., Shenzhen (CN)

(21) Appl. No.: 19/706,295

(22) Filed: Jun. 12, 2026

Related U.S. Application Data
(63) Continuation of application No. PCT/CN2024/135007, filed on Nov. 27, 2024.

(30) Foreign Application Priority Data
Dec. 15, 2023 (CN) 202311737963.5

(51) Int. Cl. G06N 3/08

(52) U.S. Cl. CPC G06N 3/08

(57) ABSTRACT

The present disclosure relates to model training methods and apparatuses. In one example model training method, a first device receives data feature information of a second local dataset from a second device, where the second local dataset is a dataset of the second device. The first device determines a first training dataset based on the data feature information of the second local dataset and a first local dataset, where the first local dataset is a dataset of the first device, and data feature information of the first training dataset includes the data feature information of the second local dataset and data feature information of the first local dataset. The first device obtains a first model based on the first training dataset, where the first model is a model deployed on the first device.

### CROSS-REFERENCE TO RELATED APPLICATIONS

This application is a continuation of International Application No. PCT/CN2024/135007, filed on Nov. 27, 2024, which claims priority to Chinese Patent Application No. 202311737963.5, filed on Dec. 15, 2023. The disclosures of the aforementioned applications are hereby incorporated by reference in their entireties.

### TECHNICAL FIELD

This application relates to the field of communication technologies, and in particular, to a model training method and a communication apparatus.

### BACKGROUND

Integrating a wireless communication system with a neural network, that is, training a neural network model in the wireless communication system in a data-driven manner, helps improve performance of the wireless communication system. The neural network model may be applied to various devices (including a receive device, a transmit device, or the like) in the wireless communication system. For example, the neural network model is applied to a channel decoding module in the receive device, data-driven training helps improve channel decoding performance of the receive device.

However, the transmit device and the receive device in a communication process may belong to different vendors. That is, a model deployed on the transmit device (a transmit model for short) and a model deployed on the receive device (a receive model for short) correspond to different training processes, which may cause the transmit device and the receive device to fail to communicate with each other. To avoid this situation, an alignment operation (also referred to adaptation or joint training) needs to be performed between the transmit model and the receive model before the transmit device and the receive device communicate with each other.

Generally, a process of aligning the transmit model with the receive model may be understood as a process of performing alignment training on the transmit model and the receive model by using data in a training dataset. However, because a training process of the transmit model and a training process of the receive model are independent, the alignment training process takes long time and incurs high overheads.

### SUMMARY

This application provides a model training method and a communication apparatus. This allows for model training with reference to a local dataset of another device, thereby facilitating subsequent model alignment with the another device, and helping shorten model alignment time.

According to a first aspect, this application provides a model training method. The method is applied to a first device or a module (for example, a chip or a chip system) in the first device. An example in which the method is applied to the first device is used. The method includes: The first device receives data feature information of a second local dataset from a second device, where the second local dataset is a dataset of the second device. Further, the first device determines a first training dataset based on the data feature information of the second local dataset and a first local dataset, where the first local dataset is a dataset of the first device, and data feature information of the first training dataset includes the data feature information of the second local dataset and data feature information of the first local dataset. The first device obtains a first model based on the first training dataset, where the first model is a model deployed on the first device. Optionally, the data feature information of the second local dataset is indicated by first indication information. In other words, the first device receives the first indication information from the second device, where the first indication information indicates the data feature information of the second local dataset.

In a possible implementation method, the first device receives the second local dataset from the second device, where the second local dataset is the dataset of the second device. Further, the first device determines the first training dataset based on the second local dataset and the first local dataset, where the first local dataset is the dataset of the first device. Further, the first device obtains the first model based on the first training dataset, where the first model is the model deployed on the first device.

Based on the method described in the first aspect, before obtaining the first model deployed on the first device, the first device obtains the first training dataset based on the data feature information of the second local dataset of the second device, and further obtains the first model based on the first training dataset. In this method, in terms of feature representation, the first model may be similar to a model (for example, a second model) obtained based on the second local dataset. This helps establish a relationship between the model (namely, the first model) on the first device and a model (namely, the second model) on the second device, thereby reducing complexity of subsequent model alignment between the first model and the second model, and helping shorten model alignment time.

In a possible implementation, the data feature information includes one or more of the following: data identification information, data distribution information, or data classification information, where the data identification information indicates data included in a dataset, the data distribution information indicates distribution of the data in the dataset, and the data classification information indicates classification of the data in the dataset.

In a possible implementation, the data distribution information includes one or more of cluster distribution information, probability distribution information, or model parameter information of a data generation model; and the data classification information includes one or more of geographic area information, signal-related information, device configuration information, quality-related information, or classification center information.

In a possible implementation, the first device determines data feature information of a second dataset difference set from the data feature information of the second local dataset based on the data feature information of the first local dataset, where the data feature information of the second dataset difference set is data feature information not included in the first local dataset. Further, the first device sends the data feature information of the second dataset difference set to the second device, and receives the second dataset difference set from the second device, where the first training dataset is a union of the second dataset difference set and the first local dataset. Optionally, the data feature information of the second dataset difference set is indicated by the second indication information. In other words, the first device sends the second indication information to the second device, and the second indication information indicates the data feature information of the second dataset difference set.

In a possible implementation, the first device aligns the first model with the second model, where the second model is a model deployed on the second device, the second model is obtained based on a second training dataset, and the data feature information of the first training dataset includes data feature information of the second training dataset. In this possible implementation, the data feature information of the first training dataset includes the data feature information of the second training dataset, and the first model and the second model that are obtained based on this are similar in terms of feature representation. Further, in a model alignment process, compared with aligning models that are not similar, this application aligns models that are somewhat similar, which helps improve a model alignment speed.

Optionally, the second training dataset includes the data feature information of the second local dataset, or the second training dataset includes the data feature information of the second local dataset and the data feature information of the first local dataset. When the second training dataset includes the data feature information of the second local dataset and the data feature information of the first local dataset, the data feature information of the second training dataset is the same as the data feature information of the first training dataset.

In a possible implementation, the first device determines data feature information of a first dataset difference set from the first local dataset based on the data feature information of the second local dataset, where the data feature information of the first dataset difference set is data feature information not included in the second local dataset. Further, the first device sends the first dataset difference set to the second device. Optionally, the first dataset difference set is indicated by third indication information. In other words, the first device sends the third indication information to the second device, and the third indication information indicates the first dataset difference set.

In a possible implementation, the first device determines a reference model based on a size of the first training dataset and a size of the second training dataset, where the reference model is the first model or the second model. Further, the first device aligns the first model with the second model based on the reference model.

In a possible implementation, the data feature information included in the first training dataset further includes data feature information of a third training dataset, the third training dataset is used to train a third model, and the third model is a model deployed on a third device.

According to a second aspect, this application provides a data transmission method. The method is applied to a second device or a module (for example, a chip or a chip system) in the second device. An example in which the method is applied to the second device is used. The method includes: The second device sends data feature information of a second local dataset to a first device, where the second local dataset is a dataset of the second device. Optionally, the data feature information of the second local dataset is indicated by the first indication information. In other words, the second device sends the first indication information to the first device, where the first indication information indicates the data feature information of the second local dataset.

In a possible implementation method, the second device sends the second local dataset to the first device.

Based on the method described in the second aspect, the second device can provide a local dataset (namely, the second local dataset) of the second device for another device (for example, the first device) for reference. This helps establish a relationship between a model (namely, a first model) on the first device and a model (namely, a second model) on the second device, thereby reducing complexity of subsequent model alignment between the first model and the second model, and helping shorten model alignment time. For beneficial effects of other implementations described in the second aspect, refer to the beneficial effects of the implementations described in the first aspect. Details are not described below again.

In a possible implementation, the data feature information includes one or more of the following: data identification information, data distribution information, or data classification information, where the data identification information indicates data included in a dataset, the data distribution information indicates distribution of the data in the dataset, and the data classification information indicates classification of the data in the dataset.

In a possible implementation, the data distribution information includes one or more of cluster distribution information, probability distribution information, or model parameter information of a data generation model; and the data classification information includes one or more of geographic area information, signal-related information, device configuration information, quality-related information, or classification center information.

In a possible implementation, the second device receives data feature information of a second dataset difference set from the first device, where the data feature information of the second dataset difference set is data feature information included in the second local dataset but not included in a first local dataset, and the first local dataset is a dataset of the first device. Further, the second device sends the second dataset difference set to the first device based on the data feature information of the second dataset difference set. Optionally, the data feature information of the second dataset difference set is indicated by second indication information. In other words, the second device receives the second indication information from the first device, where the second indication information indicates the data feature information of the second dataset difference set.

In a possible implementation, the second device aligns a first model with a second model, where the second model is a model deployed on the second device, the second model is obtained based on a second training dataset, and data feature information of a first training dataset includes data feature information of the second training dataset.

Optionally, the second training dataset includes the data feature information of the second local dataset, or the second training dataset includes the data feature information of the second local dataset and the data feature information of the first local dataset. When the second training dataset includes the data feature information of the second local dataset and the data feature information of the first local dataset, the data feature information of the second training dataset is the same as the data feature information of the first training dataset.

In a possible implementation, the second device receives a first dataset difference set from the first device, where data feature information of the first dataset difference set is data feature information included in the first local dataset but not included in the second local dataset, and the second training dataset is a union of the first dataset difference set and the second local dataset. Optionally, the first dataset difference set is indicated by third indication information. In other words, the second device receives the third indication information from the first device, and the third indication information indicates the first dataset difference set.

In a possible implementation, the second device determines a reference model based on a size of the first training dataset and a size of the second training dataset, where the reference model is the first model or the second model. Further, the second device aligns the first model with the second model based on the reference model.

In a possible implementation, the data feature information included in the first training dataset further includes data feature information of a third training dataset, the third training dataset is used to train a third model, and the third model is a model deployed on a third device.

According to a third aspect, this application provides a communication apparatus. The communication apparatus may be a first device, an apparatus in the first device, or an apparatus that can be used together with the first device. The communication apparatus may alternatively be a chip system. The communication apparatus may perform the method according to the first aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects, refer to the method and the beneficial effects in the first aspect.

According to a fourth aspect, this application provides a communication apparatus. The communication apparatus may be a second device, an apparatus in the second device, or an apparatus that can be used together with the second device. The communication apparatus may alternatively be a chip system. The communication apparatus may perform the method according to the second aspect. A function of the communication apparatus may be implemented by hardware, or may be implemented by hardware executing corresponding software. The hardware or the software includes one or more units or modules corresponding to the foregoing function. The unit or the module may be software and/or hardware. For operations performed by the communication apparatus and beneficial effects, refer to the method and the beneficial effects in the second aspect.

According to a fifth aspect, this application provides a communication apparatus. The communication apparatus includes a processor and an interface circuit. The interface circuit is configured to: receive a signal from a communication apparatus other than the communication apparatus and transmit the signal to the processor, or send a signal from the processor to a communication apparatus other than the communication apparatus; and the processor is configured to implement the method according to the first aspect through a logic circuit or by executing code instructions, or the processor is configured to implement the method according to the second aspect through a logic circuit or by executing code instructions.

According to a sixth aspect, this application provides a communication apparatus. The communication apparatus includes a processor. The processor is connected to a memory, and is configured to invoke a program stored in the memory, to perform the method according to the first aspect or the second aspect. The memory may be disposed inside the first device or the second device, or may be disposed outside the first device or the second device. In addition, there are one or more processors.

According to a seventh aspect, this application provides a computer-readable storage medium. The storage medium stores a computer program or instructions. When the computer program or the instructions are executed by a communication apparatus, the method according to the first aspect is implemented, or the method according to the second aspect is implemented.

According to an eighth aspect, this application provides a computer program product including instructions. When a communication apparatus reads and executes the instructions, the communication apparatus is enabled to perform the method according to the first aspect, or the communication apparatus is enabled to perform the method according to the second aspect.

According to a ninth aspect, this application provides a communication system, including a communication apparatus configured to perform the method according to the first aspect and a communication apparatus configured to perform the method according to the second aspect.

### BRIEF DESCRIPTION OF DRAWINGS

FIG. 1A is a diagram of an architecture of a communication system according to an embodiment of this application;

FIG. 1B is another diagram of a wireless communication system to which an embodiment of this application is applicable;

FIG. 2 is a diagram of a wireless communication system based on a neural network transmitter and a neural network receiver according to an embodiment of this application;

FIG. 3A to FIG. 3C show several diagrams of optimizing different modules in a transceiver based on a neural network model according to an embodiment of this application;

FIG. 4 is a schematic flowchart of a model training method according to an embodiment of this application;

FIG. 5 is a diagram of classification of a second local dataset according to an embodiment of this application;

FIG. 6 is a diagram of a relationship between a first local dataset and a second local dataset according to an embodiment of this application;

FIG. 7 is a schematic flowchart of a model alignment method according to an embodiment of this application;

FIG. 8A and FIG. 8B are a diagram of model alignment according to an embodiment of this application;

FIG. 9A and FIG. 9B are another diagram of model alignment according to an embodiment of this application;

FIG. 10A and FIG. 10 are still another diagram of model alignment according to an embodiment of this application;

FIG. 11 is a diagram of a structure of a communication apparatus according to an embodiment of this application; and

FIG. 12 is a diagram of a structure of another communication apparatus according to an embodiment of this application.

### DESCRIPTION OF EMBODIMENTS

For ease of specific understanding of embodiments of this application, the following first describes a system architecture in embodiments of this application.

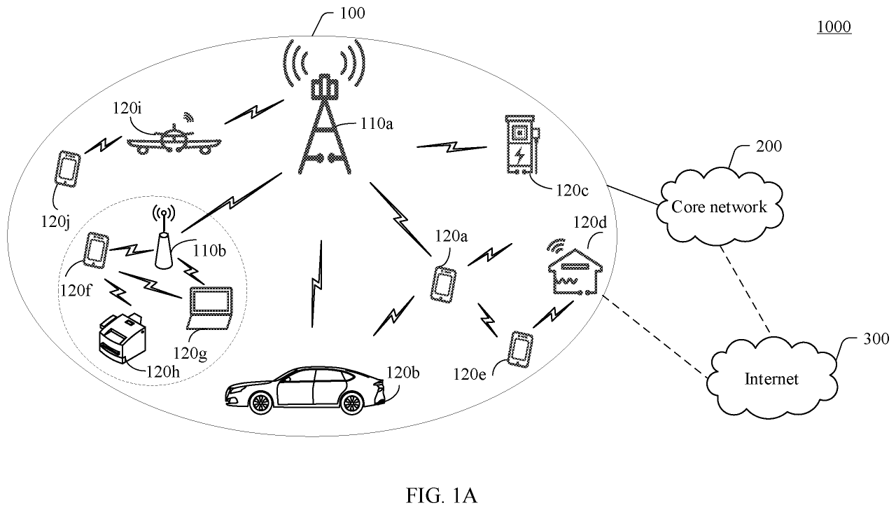

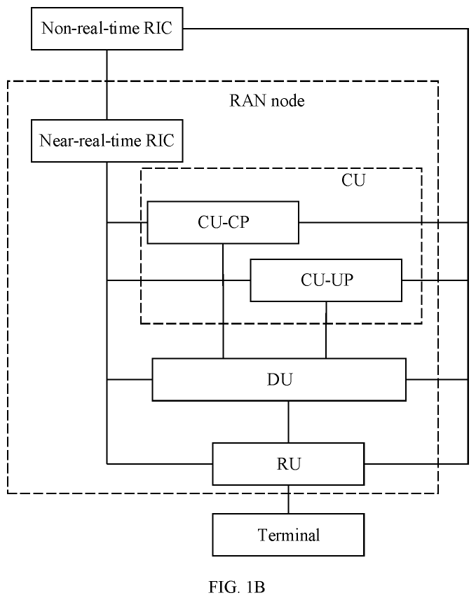

FIG. 1A is a diagram of an architecture of a communication system 1000 to which an embodiment of this application is applicable. As shown in FIG. 1A, the communication system includes a radio access network (RAN) 100 and a core network 200. Optionally, the communication system 1000 may further include an internet 300. The RAN 100 may include at least one RAN node (for example, 110a and 110b in FIG. 1A, which are collectively referred to as 110), and may further include at least one terminal (for example, 120a to 120j in FIG. 1A, which are collectively referred to as 120). The RAN 100 may further include another RAN node, for example, a wireless relay device and/or a wireless backhaul device (not shown in FIG. 1A). The terminal 120 is connected to the RAN node 110 in a wireless manner, and the RAN node 110 is connected to the core network 200 in a wireless or wired manner. A core network device in the core network 200 and the RAN node 110 in the RAN 100 may be different and separate physical devices, or may be a same physical device that integrates a logical function of the core network device and a logical function of the RAN node. Terminals may be connected to each other in a wired or wireless manner and the RAN nodes may be connected to each other in a wired or wireless manner.

The RAN 100 may be an evolved universal terrestrial radio access (E-UTRA) system, a new radio (NR) system, or a future radio access system defined in the 3rd generation partnership project (3GPP). The RAN 100 may further include the foregoing two or more different radio access systems. The RAN 100 may also be an open RAN (O-RAN).

The RAN node is also referred to as a radio access network device, a RAN entity, or an access node. The RAN node may also be referred to as a network device below, and is configured to help a terminal access a communication system in a wireless manner. In an application scenario, the RAN node may be a base station, an evolved NodeB (eNodeB), a transmission reception point (TRP), a next-generation NodeB (gNB) in a 5th generation (5G) mobile communication system, a next-generation NodeB in a 6th generation (6G) mobile communication system, or a base station in a future mobile communication system. The RAN node may be a macro base station (for example, 110a in FIG. 1A), may be a micro base station or an indoor base station (for example, 110b in FIG. 1A), or may be a relay node or a donor node.

In another application scenario, a plurality of RAN nodes may cooperate to help a terminal implement radio access, and different RAN nodes respectively implement a part of functions of a base station. For example, the RAN node may be a central unit (CU), a distributed unit (DU), or a radio unit (RU). The CU herein completes functions of a radio resource control protocol layer and a packet data convergence protocol (PDCP) layer of the base station, and may further complete functions of a service data adaptation protocol (SDAP) layer. The DU completes functions of a radio link control layer and a medium access control (MAC) layer of the base station, and may further complete some or all functions of a physical layer. For specific descriptions of the foregoing protocol layers, refer to related technical specifications in 3GPP. The RU may be configured to implement a transceiver function of a radio frequency signal. The CU and the DU may be two independent RAN nodes, or may be integrated into a same RAN node, for example, integrated into a baseband unit (BBU). The RU may be included in a radio frequency device, for example, included in a remote radio unit (RRU) or an active antenna unit (AAU). The CU may be further divided into two types of RAN nodes: a CU-control plane and a CU-user plane.

The RAN node may support one or more categories of fronthaul interfaces, and different fronthaul interfaces correspond to DUs and RUs with different functions. If a fronthaul interface between the DU and the RU is a common public radio interface (CPRI), the DU is configured to implement one or more baseband functions, and the RU is configured to implement one or more radio frequency functions. If a fronthaul interface between the DU and the RU is an enhanced common public radio interface (eCPRI), different from an implementation of the CPRI, a part of downlink baseband functions and/or uplink baseband functions are moved from the DU to the RU for implementation. Different manners of splitting between the DU and the RU correspond to different categories (Cat) of eCPRIs, for example, eCPRI Cat A, Cat B, Cat C, Cat D, Cat E, and Cat F.

The eCPRI Cat A is used as an example. For downlink transmission, splitting is based on layer mapping. The DU is configured to implement the layer mapping and one or more functions before the layer mapping (to be specific, one or more of encoding, rate matching, scrambling, modulation, and the layer mapping), and other functions after the layer mapping (for example, one or more of resource element (RE) mapping, digital beamforming (BF), or inverse fast Fourier transform (IFFT)/cyclic prefix (CP) addition) are moved to the RU for implementation. For uplink transmission, splitting is based on RE demapping. The DU is configured to implement demapping and one or more functions before the demapping (to be specific, one or more of decoding, de-rate matching, descrambling, demodulation, inverse discrete Fourier transform (IDFT), channel equalization, and the RE demapping), and other functions (for example, one or more of digital BF or fast Fourier transform (FFT)/CP removal) after the demapping are moved to the RU for implementation. It may be understood that, for function descriptions of DUs and RUs corresponding to various categories of eCPRIs, refer to an eCPRI protocol. Details are not described herein.

In a possible design, a processing unit for implementing a baseband function in the BBU is referred to as a baseband high (BBH) unit, and a processing unit for implementing a baseband function in the RRU/AAU/RRH is referred to as a baseband low (baseband low, BBL) unit.

In different systems, the RAN node may have different names. For example, in an O-RAN system, a CU may be referred to as an open CU (O-CU), a DU may be referred to as an open DU (O-DU), and an RU may be referred to as an open RU (O-RU). The RAN node in embodiments of this application may be implemented by using a software module, a hardware module, or a combination of a software module and a hardware module. For example, the RAN node may be a server loaded with a corresponding software module. A specific technology and a specific device form that are used by the RAN node are not limited in embodiments of this application. For ease of description, the following uses a base station as an example of the RAN node for description.

The terminal is a device with a wireless transceiver function, and may send a signal to the base station, or receive a signal from the base station. The terminal may also be referred to as a terminal device, user equipment (UE), a mobile station, a mobile terminal, or the like. The terminal may be widely used in various scenarios, for example, device-to-device (D2D), vehicle to everything (V2X) communication, machine-type communication (MTC), internet of things (IOT), virtual reality, augmented reality, industrial control, autonomous driving, telemedicine, a smart grid, smart furniture, a smart office, smart wearable, smart transportation, and a smart city. The terminal may be a mobile phone, a tablet computer, a computer with a wireless transceiver function, a wearable device, a vehicle, an airplane, a ship, a robot, a robotic arm, a smart home device, or the like. A specific technology and a specific device form that are used by the terminal are not limited in embodiments of this application.

The base station and the terminal may be fixed or movable. The base station and the terminal may be deployed on land, including an indoor or outdoor scenario, and a handheld or a vehicle-mounted scenario; or may be deployed on water; or may be deployed on an airplane, a balloon, and a man-made satellite. Application scenarios of the base station and the terminal are not limited in embodiments of this application.

Roles of the base station and the terminal may be relative. For example, a helicopter or an uncrewed aerial vehicle 120i in FIG. 1A may be configured as a mobile base station, and for a terminal 120j accessing the radio access network 100 through 120i, the terminal 120i is a base station. However, for the base station 110a, 120i is a terminal. In other words, communication between 110a and 120i is performed based on a radio air interface protocol. Certainly, communication between 110a and 120i may alternatively be performed based on an interface protocol between base stations. In this case, for 110a, 120i is also a base station. Therefore, both the base station and the terminal may be collectively referred to as a communication apparatus, 110a and 110b in FIG. 1A may be referred to as a communication apparatus having a function of a base station, and 120a to 120j in FIG. 1A may be referred to as a communication apparatus having a function of a terminal.

Communication between the base station and the terminal, between base stations, or between terminals may be performed by using a licensed spectrum, or may be performed by using an unlicensed spectrum, or may be performed by using both the licensed spectrum and the unlicensed spectrum. Communication may be performed by using a spectrum below 6 gigahertz (GHz), or may be performed by using a spectrum above 6 GHz, or may be simultaneously performed by using the spectrum below 6 GHz and the spectrum above 6 GHz. A spectrum resource used for wireless communication is not limited in embodiments of this application.

In embodiments of this application, a function of the base station may be performed by a module (for example, a chip) in the base station, or may be performed by a control subsystem including the function of the base station. The control subsystem including the function of the base station herein may be a control center in the foregoing application scenarios, such as a smart grid, industrial control, smart transportation, and a smart city. A function of the terminal may be performed by a module (for example, a chip or a modem) in the terminal, or may be performed by an apparatus including the function of the terminal.

FIG. 1B is another diagram of a wireless communication system to which an embodiment of this application is applicable.

As shown in FIG. 1B, the wireless communication system includes a RAN intelligent controller (RIC). As an example, the RIC may be used to implement artificial intelligence (AI)-related functions. For example, the RIC includes a near-real-time RIC (near-RT RIC) and a non-real-time RIC (Non-RT RIC). The non-real-time RIC mainly processes non-real-time information, for example, delay-insensitive data. A delay of the data may be on a scale of seconds. The near-real-time RIC mainly processes near-real-time information, for example, delay-sensitive data. A delay of the data is on a scale of tens of milliseconds.

The near-real-time RIC is configured to perform model training and inference, for example, is configured to: train an AI model and perform inference based on the AI model. The near-real-time RIC may obtain network-side information and/or terminal-side information from a RAN node (for example, a CU, a CU-CP, a CU-UP, a DU, and/or an RU) and/or a terminal. The information may be used as training data or inference data. Optionally, the near-real-time RIC may deliver an inference result to the RAN node and/or the terminal. Optionally, the inference result may be exchanged between the CU and the DU and/or between the DU and the RU. For example, the near-real-time RIC delivers the inference result to the DU, and the DU sends the inference result to the RU.

The non-real-time RIC is also configured to perform model training and inference, for example, is configured to: train an AI model and perform inference based on the model. The non-real-time RIC may obtain network-side information and/or terminal-side information from a RAN node (for example, a CU, a CU-CP, a CU-UP, a DU, and/or an RU) and/or a terminal. The information may be used as training data or inference data, and an inference result may be delivered to the RAN node and/or the terminal. Optionally, the inference result may be exchanged between the CU and the DU and/or between the DU and the RU. For example, the non-real-time RIC delivers the inference result to the DU, and the DU sends the inference result to the RU.

The near-real-time RIC and the non-real-time RIC each may alternatively be independently deployed as a network element. Optionally, the near-real-time RIC and the non-real-time RIC may alternatively serve as a part of another device. For example, the near-real-time RIC is deployed on the RAN node (for example, the CU or the DU), and the non-real-time RIC is deployed on operation, administration and maintenance (OAM), a cloud server, a core network device, or another network device.

During actual application, the wireless communication system may include a plurality of network devices (also referred to as access network devices), and may include a plurality of terminal devices. This is not limited. One network device may serve one or more terminal devices. One terminal device may also access one or more network devices. Quantities of terminal devices and network devices included in the wireless communication system are not limited in embodiments of this application.

For ease of understanding of related content of embodiments of this application, the following further explains and describes some terms in embodiments of this application. This part is merely for ease of understanding, and cannot be considered as a disclosure or a specific limitation on the technical solutions of this application.

### 1. Neural Network

The neural network may include neurons. A neuron may be an operation unit that uses xₛ as an input and whose output may be shown in Formula (1).

$${h}_{W , b} ( x ) = f ( {\sum }_{s = 1}^{n} {W}_{s} {x}_{s} + b ) \qquad ( 1 )$$

s=1, 2, . . . , and n, where n is a natural number greater than 1, Wₛ is a weight of xₛ, and b is a bias of the neuron. f is an activation function of the neuron, and is used to introduce a nonlinear characteristic into the neural network, to convert an input signal in the neuron into an output signal. The output signal of the activation function may be used as an input of a next convolutional layer. The activation function may be a sigmoid function. The neural network is a network formed by connecting many single neurons together, that is, an output of one neuron may be an input of another neuron. An input of each neuron may be connected to a local receptive field in a previous layer to extract a feature from the local receptive field. The local receptive field may be a region formed by several neurons.

It should be noted that the neural network model mentioned in this application may be one or more of a network model of a neural network, a network model of a deep neural network (DNN), a network model of a convolutional neural network (CNN), a network model of a recurrent neural network (RNN), a network model of a generative adversarial network, or a variation or combination thereof. This is not specifically limited in this application.

### 2. Intelligent Air Interface Technology

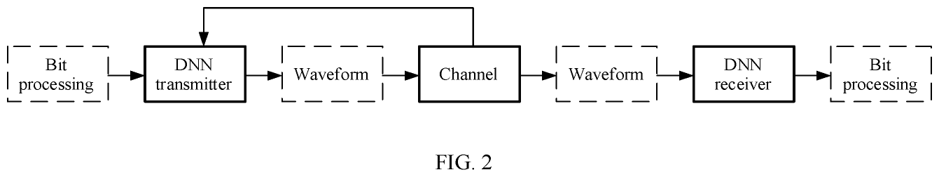

The intelligent air interface technology may be understood as a technology that uses a neural network model in a wireless communication system to optimize performance of the wireless communication system. FIG. 2 shows a wireless communication system based on a neural network transmitter and a neural network receiver (collectively referred to as a transceiver below) according to this application. In the system shown in FIG. 2, for a transceiver to which a neural network model is used, performance of signal transmission and reception can be optimized through data-driven training.

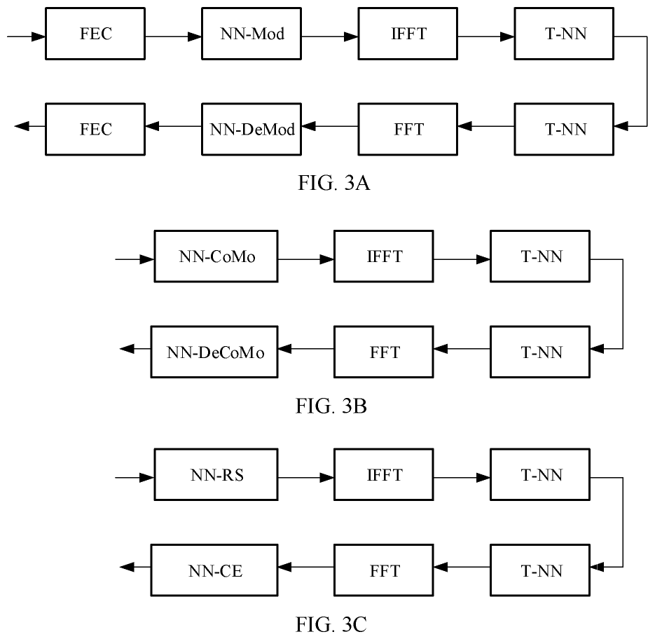

It may be understood that optimizing performance of the transceiver based on a neural network model means using the neural network model to optimize modules used for signal processing in the transceiver, such as channel encoding, modulation, waveform, and pilot. For example, FIG. 3A to FIG. 3C show several diagrams of optimizing different modules in a transceiver based on a neural network model according to an embodiment of this application. FIG. 3A is a diagram of optimizing a modulation module and a waveform based on a neural network model. FIG. 3B is a diagram of optimizing an encoding module and a modulation module based on a neural network model. FIG. 3C is a diagram of optimizing a reference signal based on a neural network model.

In FIG. 3A, a to-be-transmitted bit is encoded by a transmit device through forward error correction (FEC) to obtain an encoded bit, and the encoded bit is modulated based on a modulation neural network model (namely, an NN-Mod module in FIG. 3A), mapped to a physical resource, transformed to a time domain signal through inverse fast Fourier transform (IFFT), processed based on a time signal neural network model (namely, a T-NN module in FIG. 3A), and then sent. A received signal is first processed by a time signal neural network model of a receive device, transformed to a frequency domain signal through fast Fourier transform (FFT), demodulated based on a demodulation neural network model (namely, an NN-DeMod module in FIG. 3A), and then sent for FEC decoding.

In FIG. 3B, a to-be-transmitted bit is processed by an encoding and modulation neural network model (namely, an NN-CoMo module in FIG. 3B) of the transmit device to obtain a modulation symbol, and the modulation symbol is processed by a module such as IFFT and then sent. The receive device directly sends a signal processed by the module such as FFT to a decoding and demodulation neural network model (namely, an NN-DeCoMo module in FIG. 3B) for processing, to obtain an estimated to-be-sent bit.

In FIG. 3C, the transmit device generates a reference signal based on a reference signal neural network model (namely, an NN-RS module in FIG. 3C), and the receive device processes a received signal based on the reference signal and a corresponding channel estimation neural network model (namely, an NN-CE module in FIG. 3C) to obtain an estimated channel.

During application of the intelligent air interface technology, a model deployed on the transmit device (a transmit model for short) and a model deployed on the receive device (a receive model for short) may correspond to different training processes. For example, the transmit device and the receive device belong to different vendors. In this case, if the transmit model and the receive model are not aligned before communication between the transmit device and the receive device, the receive model may fail to parse data processed by the transmit model. Consequently, the transmit device and the receive device cannot communicate with each other. Usually, a process of model alignment between the transmit model and the receive model is a process of performing alignment training (or understood as joint training, adaptation training, or the like) on the transmit model and the receive model by using data in a training dataset. The model alignment process takes a long time, and causes high overheads.

This application provides a model training method, for improving a correlation between a training dataset corresponding to a transmit model and a training dataset corresponding to a receive model, thereby helping improve a correlation between the transmit model and the receive model, and facilitating subsequent model alignment. The following further describes, with reference to the accompanying drawings, the model training method and the communication apparatus provided in this application.

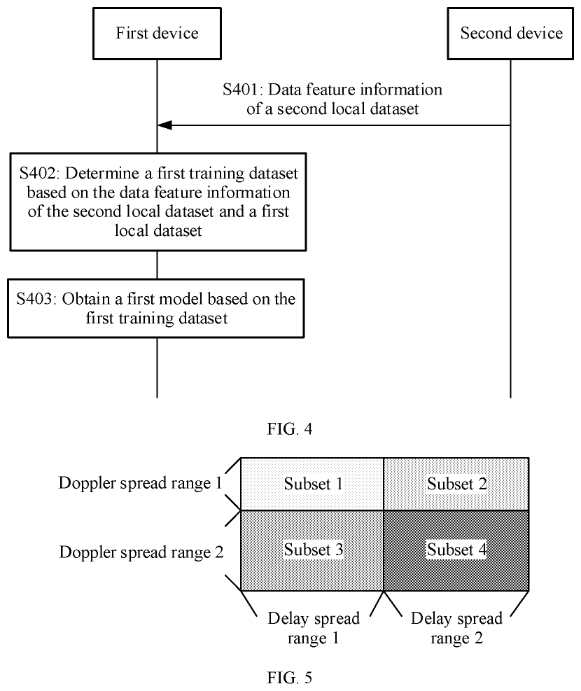

FIG. 4 is a schematic flowchart of a model training method according to an embodiment of this application. As shown in FIG. 4, the model training method includes S401 to S403. The method shown in FIG. 4 may be performed by a first device and a second device, or the method shown in FIG. 4 may be performed by a module in the first device and a module in the second device, or the method shown in FIG. 4 may be performed by a chip in the first device and a chip in the second device. FIG. 4 is described by using an example in which the method is performed by the first device and the second device. It should be noted that the first device (or the second device) mentioned in this application may be the network device shown in FIG. 1A, or may be the terminal device shown in FIG. 1A. This is not specifically limited in this application. It should also be noted that the first device in this application may be a transmit device or a receive device in a communication process, and the second device in this application may also be a transmit device or a receive device. When the first device is a transmit device, the second device is a receive device. When the first device is a receive device, the second device is a transmit device.

S401: The second device sends data feature information of a second local dataset to the first device, where the second local dataset is a dataset of the second device.

It may be understood that in this application, one or more of a dataset collected by the first device, a dataset generated by a data generation model, or a stored dataset are denoted as a first local dataset, and the first local dataset is a dataset of the first device; and one or more of a dataset collected by the second device, a dataset generated by a data generation model, or a stored dataset are denoted as the second local dataset, and the second local dataset is a dataset of the second device. After the second device obtains the data feature information of the second local dataset, the second device indicates the data feature information of the second local dataset to the first device. In the following, an example in which the second device indicates the data feature information of the second local dataset to the first device by using first indication information is used for description in this application.

The data feature information indicates a feature of data included in the second local dataset. A specific representation form of the data feature information is not specifically limited in this application. For ease of understanding, in this application, several types of data feature information are provided as an example for description, and this should not be considered as a specific limitation on this application. In a possible implementation method, the data feature information includes one or more of data identification information, data distribution information, or data classification information.

\textcircled{1}. The data identification information indicates data included in a dataset. The data identification information may be an identity document (ID) of the data in the dataset. In this case, the first indication information includes IDs of all data in the second local dataset.

\textcircled{2}. The data distribution information (or referred to as data statistical information) indicates distribution of the data in the dataset. The data distribution information may be cluster distribution information (for example, a quantity of clusters corresponding to the second local dataset, a cluster center of each cluster, a size of each cluster, or cluster density of each cluster), probability distribution information (parameters indicating probability distribution that the data in the dataset follows; for example, if data in the second local dataset follows Gaussian distribution, the probability distribution information is a mean and a variance of the Gaussian distribution), or model parameter information of a data generation model (used to indicate model parameters for generating the data, in a case in which the data in the dataset is generated by the data generation model). \textcircled{3}. The data classification information indicates classification of the data in the dataset. The data classification information includes one or more of category information of the dataset, a size of a subset corresponding to each category (namely, an amount of data included in each subset), or data included in the subset corresponding to each category. It should be noted that the category information of the dataset is not specifically limited in this application. The category information may be geographic area information (for example, a cell ID, a site ID, and longitude and latitude information of a data collection device), signal-related information (for example, Doppler spread information, delay spread information, or an antenna-related coefficient corresponding to a signal during data collection), device configuration information (for example, a moving speed or antenna configuration information of the data collection device), quality-related information (for example, data processing algorithm-related information present when the data is obtained, and channel estimation accuracy information present when data is collected), and classification center information (for example, cluster distribution information corresponding to the dataset).

For example, a plurality of signals included in the second local dataset are classified based on the Doppler spread information and the delay spread information, to obtain four subsets (namely, a subset 1 to a subset 4) shown in FIG. 5. The subset 1 corresponds to a Doppler spread range 1 and a delay spread range 1, the subset 2 corresponds to the Doppler spread range 1 and a delay spread range 2, the subset 3 corresponds to a Doppler spread range 2 and the delay spread range 1, and the subset 4 corresponds to the Doppler spread range 2 and the delay spread range 2. Further, the second device sends the first indication information to the first device, where the first indication information indicates the Doppler spread range and the delay spread range that correspond to each of the subset 1 to the subset 4 included in the second local dataset, or the first indication information indicates an amount or a proportion of data included in each subset in the second local dataset.

It should be noted that a manner in which a device obtains data feature information of a local dataset of the device is not specifically limited in this application, that is, a manner in which the second device obtains the data feature information of the second local dataset is not limited in this application, and a manner in which the first device obtains data feature information of the first local dataset is not limited either in this application. For example, the second device analyzes the second local dataset based on a data feature information analysis model (for example, a clustering algorithm), to obtain the data feature information of the second local dataset; or the second device may obtain the data feature information of the second local dataset from attribute information (which may be understood as including information used to describe the local dataset) of the second local dataset, without analyzing the second local dataset based on the data feature information analysis model.

It should also be noted that the devices in this application have a consensus on the data feature information (that is, understanding is consistent). For example, when the first indication information indicates that the data feature information of the second local dataset is data identification information, the data feature information of the first local dataset of the first device is also data identification information; when the first indication information indicates that the data feature information of the second local dataset is data distribution information, and the data distribution information is cluster distribution information, the data feature information of the first local dataset of the first device is also cluster distribution information; or when the first indication information indicates that the data feature information of the second local dataset is data classification information, and the second local dataset is classified based on the Doppler spread range 1 and the delay spread range 1, the data feature information of the first local dataset of the first device is also classified based on the Doppler spread range 1, another Doppler spread range (a range other than the Doppler spread range 1), the delay spread range 1, and another delay spread range (namely, a range other than the delay spread range 1).

In a possible implementation, before S401 is performed, the first device and the second device may perform dataset alignment negotiation (or understood as starting a dataset alignment process, that is, triggering execution of S401 and S402).

For example, in a possible implementation, the first device sends a dataset alignment request message to the second device; the second device sends a dataset alignment acknowledgment message to the first device based on the dataset alignment request message; and further, the second device sends the first indication information to the first device. The dataset alignment acknowledgment message may be the same as or different from a message that carries the first indication information in S401.

For another example, in a possible implementation, the second device sends a dataset alignment request message to the first device; the first device sends a dataset alignment acknowledgment message to the second device based on the dataset alignment request message; and further, the second device sends the first indication information to the first device.

S402: The first device determines a first training dataset based on the data feature information of the second local dataset and the first local dataset, where the first local dataset is a dataset of the first device, and data feature information of the first training dataset includes the data feature information of the second local dataset and the data feature information of the first local dataset.

In other words, the first device obtains the first training dataset with reference to the data feature information of the first local dataset and the data feature information of the second local dataset. The first training dataset may be a union of the first local dataset and the second local dataset, or the data feature information of the first training dataset includes the data feature information of the first local dataset and the data feature information of the second local dataset.

In a possible implementation of S402, the first device generates, based on the data feature information of the second local dataset, a dataset (denoted as a first generated dataset) that has the same data feature information as the second local dataset. Further, the first device determines the first training dataset based on the first generated dataset and the first local dataset, where the first training dataset is a union of the first generated dataset and the first local dataset.

For example, the data feature information of the second local dataset is model parameter information of a data generation model 1. In this case, the first device constructs the data generation model 1 based on the model parameter information, and generates the first generated dataset based on the data generation model 1. Further, the first device determines, as the first training dataset, the union of the first generated dataset and the first local dataset. In other words, the data feature information of the first training dataset includes the data feature information of the first local dataset and the data feature information of the second local dataset.

In another possible implementation of S402, the first device determines data feature information of a second dataset difference set from the second local dataset based on the data feature information of the first local dataset, where the data feature information of the second dataset difference set is data feature information not included in the first local dataset. Further, the first device sends the data feature information of the second dataset difference set to the second device, receives the second dataset difference set from the second device, and determines the first training dataset based on the second dataset difference set and the first local dataset. The first training dataset is a union of the first local dataset and the second dataset difference set. In the following, an example in which the first device indicates the data feature information of the second dataset difference set to the second device by using second indication information is used for description in this application.

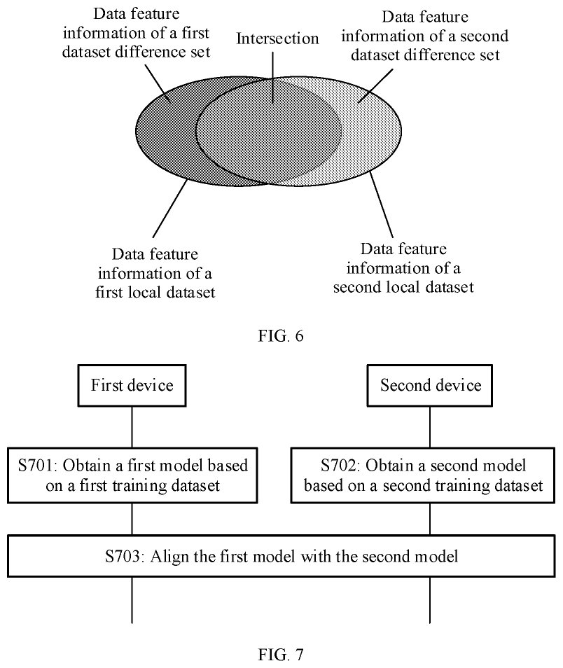

For ease of understanding, with reference to FIG. 6, there is an intersection of the data feature information of the first local dataset and the data feature information of the second local dataset. The intersection may be an empty set or a non-empty set. This is not specifically limited in this application. In this application, a difference set of the data feature information of the first local dataset and the intersection is referred to as data feature information of a first dataset difference set, and a difference of the data feature information of the second local dataset and the intersection is referred to as the data feature information of the second dataset difference set. After receiving the data feature information of the second local dataset, the first device compares the data feature information of the first local dataset with the data feature information of the second local dataset, and determines, from the data feature information of the second local dataset, data feature information (namely, the data feature information of the second dataset difference set) different from the data feature information of the first local dataset. Further, the first device sends the second indication information to the second device, where the second indication information indicates the data feature information of the second dataset difference set. The second device sends the second dataset difference set to the first device based on the data feature information indicated by the second indication information. Further, the first device determines, as the first training dataset, the union of the second dataset difference set and the first local dataset.

S403: The first device obtains a first model based on the first training dataset, where the first model is a model deployed on the first device.

In other words, the first device trains a neural network model based on the first training dataset, to obtain the first model. The first model may be a model deployed in a transmitter of the first device, or may be a model deployed in a receiver of the first device.

In conclusion, the first device obtains the first training dataset based on the data feature information of the second local dataset of the second device, and obtains the first model based on the first training dataset. It may be understood that in terms of feature representation, the first model is similar to a model (for example, a second model) obtained based on the second local dataset. This helps establish a relationship between the model (namely, the first model) on the first device and a model (namely, the second model) on the second device, thereby reducing complexity of subsequent model alignment between the first model and the second model, and helping shorten model alignment time.

Optionally, this application further provides a specific application scenario to which FIG. 4 is applicable. In the application scenario, the first device may be an access network device, and the second device is a terminal device that is served by the first device. Alternatively, the first device is a terminal device, and the second device is an access network device that is served by the first device.

For ease of understanding a model alignment process mentioned in this application, refer to FIG. 7. FIG. 7 is a schematic flowchart of a model alignment method according to an embodiment of this application. As shown in FIG. 7, the model alignment method includes S701 to S703. The method shown in FIG. 7 may be performed by a first device and a second device, or the method shown in FIG. 7 may be performed by a module in the first device and a module in the second device, or the method shown in FIG. 7 may be performed by a chip in the first device and a chip in the second device. FIG. 7 is described by using an example in which the method is performed by the first device and the second device. It should be noted that, for descriptions of the first device and the second device, refer to the descriptions of the first device and the second device in FIG. 4. Details are not described herein again.

S701: The first device obtains a first model based on a first training dataset.

For descriptions of S701, refer to the descriptions of the specific implementations of S401 to S403. Details are not described herein again.

S702: The second device obtains a second model based on a second training dataset.

In other words, the second device trains a neural network model based on the second training dataset, to obtain the second model. The second model is a model deployed on the second device. For example, the second model is a model deployed in a transmitter of the second device, or may be a model deployed in a receiver of the second device.

Data feature information of the first training dataset includes data feature information of the second training dataset. It should be noted that for descriptions of the data feature information and the first training dataset, refer to related descriptions of the data feature information and the first training dataset in S401 to S403. Details are not described herein again.

For ease of understanding, a relationship between the first training dataset and the second training dataset is described below in the following two cases.

Case 1: The second training dataset is a second local dataset.

In other words, the second training dataset includes data feature information of the second local dataset. In this case, in addition to the data feature information of the second training dataset, the data feature information of the first training dataset further includes other data feature information. For example, as shown in FIG. 6, the data feature information of the first training dataset further includes data feature information of a first dataset difference set.

In a possible implementation, in addition to the data feature information of the second training dataset, the data feature information of the first training dataset further includes data feature information of a third training dataset, the third training dataset is used to train a third model, and the third model is a model deployed on a third device.

For example, a center node maintains a first local dataset, a distributed node 1 maintains the second local dataset, and a distributed node 2 maintains a third local dataset. The center node sends data feature information of the first local dataset to the distributed node 1 and the distributed node 2. The distributed node 1 sends indication information 1 to the center node based on the data feature information of the first local dataset and the data feature information of the second local dataset, where the indication information 1 indicates a second dataset difference set, and the second dataset difference set includes data corresponding to data feature information included in the second local dataset but not included in the first local dataset. The distributed node 2 sends indication information 2 to the center node based on the data feature information of the first local dataset and data feature information of the third local dataset, where the indication information 2 indicates a third dataset difference set, and the third dataset difference set includes data corresponding to data feature information included in the third local dataset but not included in the first local dataset. Further, the center node determines, as the first training dataset, a union of the first local dataset, the second dataset difference set, and the third dataset difference set, to obtain the first model deployed on the center node. The distributed node 1 determines the second local dataset as the second training dataset, to obtain the second model deployed on the distributed node 1. The distributed node 2 determines the third local dataset as the third training dataset, to obtain the third model deployed on the distributed node 2. In other words, the data feature information of the first training dataset includes feature information of the second training dataset and feature information of the third training dataset. Optionally, in an application scenario of the example, the center node may be an access network device or a core network device, and the plurality of distributed nodes may be different terminal devices.

Case 2: The second training dataset is a union of a second local dataset and a first dataset difference set.

In this case, the data feature information of the first training dataset is the same as the data feature information of the second training dataset. In other words, the second training dataset includes data feature information of the second local dataset and data feature information of a first local dataset. In a possible implementation, after obtaining the data feature information of the second local dataset, the first device determines data feature information of the first dataset difference set from the first local dataset based on the data feature information of the second local dataset, where the data feature information of the first dataset difference set is data feature information included in the first local dataset but not included in the second local dataset. Further, the first device sends the first dataset difference set to the second device, and the second device determines, as the second training dataset, a union of the first dataset difference set and the second local dataset. Optionally, the first device indicates the first dataset difference set to the second device by using the third indication information.

For ease of understanding, as shown in FIG. 6, the data feature information of the first training dataset is a union of the data feature information of the first local dataset and data feature information of a second dataset difference set, and the data feature information of the second training dataset is a union of the data feature information of the second local dataset and the data feature information of the first dataset difference set. In other words, the data feature information of the first training dataset is the same as the data feature information of the second training dataset.

S703: The first device and the second device align the first model with the second model.

In other words, the first device and the second device align the first model with the second model (or understand as alignment training, adaptation training, or joint training) based on alignment data (which may be understood as training data used for model alignment). It may be understood that an objective of aligning the first model with the second model is to enable the first device to communicate with the second device normally.

For example, in Example 1, the first model is a model deployed in a transmitter of the first device, and the second model is a model deployed in the receiver of the second device. After the first model is aligned with the second model, the first model processes data #1 to obtain data #2, the first device sends the data #2 to the second device, and the second model processes the data #2 to obtain data #3. The data #3 is close to the data #1, in other words, an error between the data #3 and the data #1 is small (for example, the error is less than a first threshold, and a specific value of the first threshold is not limited in this application).

For example, in Example 2, the first model is a model deployed in a receiver of the first device, and the second model is a model deployed in the transmitter of the second device. After the first model is aligned with the second model, the second model processes data #1 to obtain data #2, the second device sends the data #2 to the first device, and the first model processes the data #2 to obtain data #3. The data #3 is close to the data #1, in other words, an error between the data #3 and the data #1 is small.

In a possible implementation, aligning the first model with the second model includes but is not limited to the following three manners:

Manner 1: Joint training is performed on the first model and the second model.

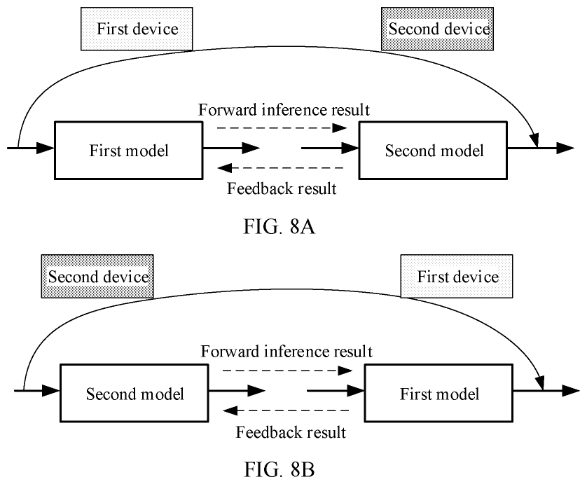

For a joint training process, refer to FIG. 8A and FIG. 8B. When the first model is a model deployed in the transmitter of the first device (namely, a transmit device), and the second model is a model deployed in the receiver of the second device (namely, a receive device), the joint training process is shown in FIG. 8A. When the first model is a model deployed in the receiver of the first device (namely, a receive device), and the second model is a model deployed in the transmitter of the second device (namely, a transmit device), the joint training process is shown in FIG. 8B.

The following uses FIG. 8A as an example to describe the joint training process. The first device performs forward inference on the alignment data based on the first model, to obtain a forward inference result, and sends the forward inference result to the second device. After receiving the forward inference result from the first device, the second device performs computation (for example, including at least one of forward inference, loss function computation, or reverse gradient computation) on the forward inference result based on the second model, to obtain a feedback result, and feeds back the feedback result to the first device. The feedback result may be a loss result obtained through inference computation based on the second model, or a gradient obtained through reverse gradient computation based on the second model. This is not specifically limited in this application. The first device updates a model parameter of the first model based on the feedback result and the forward inference result. Optionally, the second device may further update a model parameter of the second model based on the forward inference result.

Manner 2: Adaptation training is performed on the first model and the second model based on a third model in an adaptation node. The adaptation node is the first device or the second device.

It should be understood that, when the adaptation node is the first device, if the first model is a model deployed in the transmitter of the first device and the second model is a model deployed in the receiver of the second device, the third model is a model deployed in the receiver of the first device; or if the first model is a model deployed in the receiver of the first device and the second model is a model deployed in the transmitter of the second device, the third model is a model deployed in the transmitter of the first device. When the adaptation node is the second device, if the first model is a model deployed in the transmitter of the first device and the second model is a model deployed in the receiver of the second device, the third model is a model deployed in the transmitter of the second device; or if the first model is a model deployed in the receiver of the first device and the second model is a model deployed in the transmitter of the second device, the third model is a model deployed in the receiver of the second device.

It should also be noted that a manner of determining the adaptation node is not specifically limited in this application. For example, the first device and the second device determine the adaptation node based on a size of the first training dataset and a size of the second training dataset. The adaptation node may be a device with a large training dataset, or may be a device with a small training dataset. This is not specifically limited in this application. For ease of understanding, an example in which the adaptation node is a device (namely, the first device) with a large training dataset is used for description below.

In a possible implementation of Manner 2, the adaptation node constructs a fourth training dataset based on the third model, and the adaptation node sends the fourth training dataset to another device (namely, a device that is not an adaptation node in the first device and the second device). It may be understood that the first device and the second device align the first model with the second model based on the fourth training dataset.

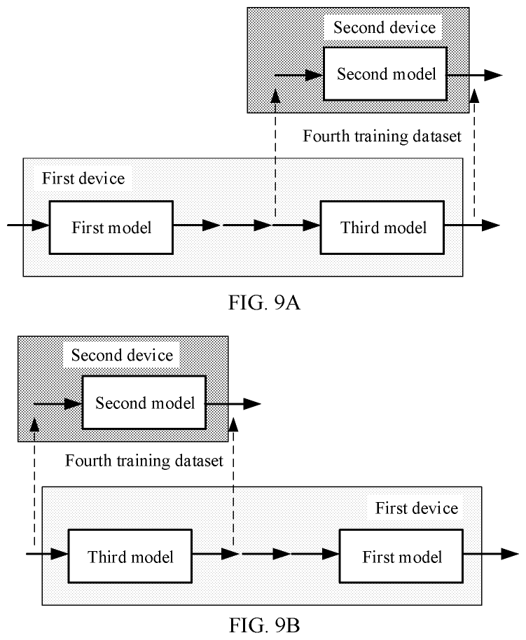

For example, the first device is an adaptation node, and the first device trains, based on the first training dataset, the model deployed in the transmitter of the first device and the model deployed in the receiver. For an adaptation training process, refer to FIG. 9A and FIG. 9B. When the first model is a model deployed in the transmitter of the first device (namely, a transmit device), the third model is a model deployed in the receiver of the first device, and the second model is a model deployed in the receiver of the second device (namely, a receive device), the adaptation training process is shown in FIG. 9A. When the first model is a model deployed in the receiver of the first device (namely, a receive device), the third model is a model deployed in the transmitter of the first device, and the second model is a model deployed in the transmitter of the second device (namely, a transmit device), the adaptation training process is shown in FIG. 9B. FIG. 9A is used as an example to describe the adaptation training process. The first device constructs the fourth training dataset based on an input of the third model (namely, an output of the first model) and an output of the third model, and sends the fourth training dataset to the second device. The second device trains the second model based on the fourth training dataset, so that when an input of the second model is the same as the input of the third model, an output of the second model is as close as possible to the output of the third model (or understood as a small error).

In another possible implementation of Manner 2, the adaptation node constructs a training reference model based on the third model, and the adaptation node sends a model parameter of the training reference model to another device (namely, a device that is not an adaptation node in the first device and the second device). It may be understood that the first device and the second device align the first model with the second model based on the training reference model.

For example, the first device is an adaptation node, the first device is a transmit device, and the second device is a receive device. The first device trains the model deployed in the transmitter (namely, the first model mentioned in this application) and the model deployed in the receiver (namely, the third model mentioned in this application) in the first device based on the first training dataset, and the second device trains the model deployed in the receiver of the second device (namely, the second model mentioned in this application) based on the second training dataset. In this case, the first device constructs a receiver training reference model based on the third model. When an input of the receiver training reference model is the same as an input of the third model, an output of the receiver training reference model is the same as or similar to an output of the third model. Further, the first device sends a model parameter of the receiver training reference model to the second device. The second device constructs a fifth training dataset based on the model parameter of the receiver training reference model, and trains the second model based on the fifth training dataset, so that when an input of the second model is the same as the input of the receiver training reference model, an output of the second model is as close as possible to the output of the receiver training reference model.

Manner 3: The first model is aligned with the second model based on a reference model. The reference model is the first model or the second model, and the reference model is determined by the first device and the second device based on a size of the first training dataset and a size of the second training dataset.

It should be noted that the reference model may be one of the first model and the second model, that is obtained based on the larger training dataset (namely, a training dataset corresponding to the larger of a first data amount and a second data amount); or the reference model may be one of the first model and the second model, that is obtained based on the smaller training dataset (namely, a training dataset corresponding to the smaller of a first data amount and a second data amount). This is not specifically limited in this application.

In other words, before the first model and the second model are aligned, the first device and the second device exchange the size (denoted as the first data amount) of the first training dataset and/or the size (denoted as the second data amount) of the second training dataset. Further, the first device and/or the second device may determine the reference model based on the first data amount and the second data amount.

For example, in Example 3, the first device sends the first data amount to the second device. After obtaining the first data amount, the second device determines that a value of the first data amount is greater than a value of the second data amount. Further, the second device determines the first model as the reference model. The second device sends fourth indication information to the first device, where the fourth indication information indicates that the reference model is the first model. Further, the second device and the first device align the second model with the first model based on the first model. In Example 4, the second device sends the second data amount to the first device. After obtaining the second data amount, the first device determines that a value of the first data amount is greater than a value of the second data amount. Further, the first device determines the first model as the reference model. The first device sends fifth indication information to the second device, where the fifth indication information indicates that the reference model is the first model. Further, the second device and the first device align the second model with the first model based on the first model. In Example 5, the first device sends the first data amount to the second device, and the second device sends the second data amount to the first device. The first device and the second device determine that a value of the first data amount is greater than a value of the second data amount. Further, the first device and the second device determine the first model as the reference model. Further, the second device and the first device align the second model with the first model based on the first model.

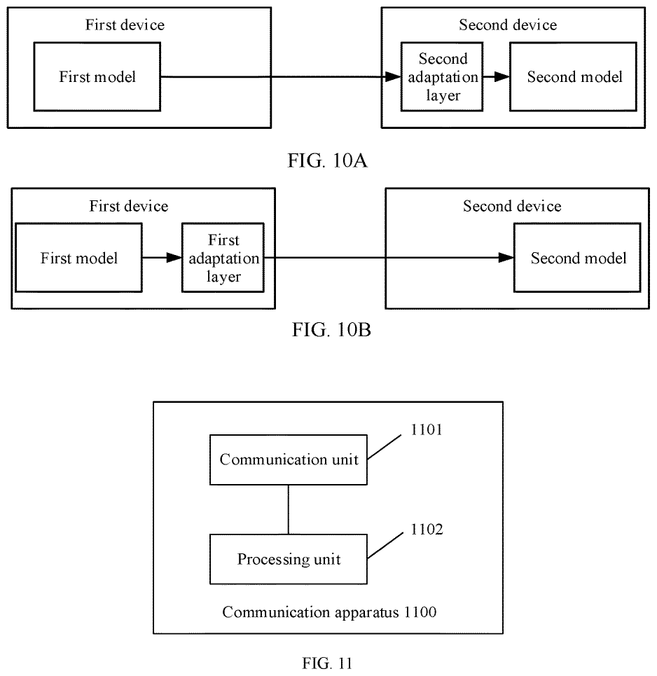

In a possible implementation of Manner 3, when the reference model is the first model, the second device trains the second model and a second adaptation layer based on the first model. For example, when the first device is a transmit device, the second device is a receive device, the first model is a model deployed in the transmitter of the first device, and the second model is a model deployed in the receiver of the second device, an adaptation training process is shown in FIG. 10A. The first device processes data #1 based on the first model to obtain data #2, and the first device sends the data #2 to the second device. The second device processes the data #2 by using the second adaptation layer to obtain data #3, and processes the data #3 based on the second model to obtain data #4. A training objective of the adaptation training may be understood as making a small error between the data #4 and the data #1. Alternatively, a training objective may be understood as that, in the case of a same input, an output obtained through joint processing of the second adaptation layer and the second model is as close as possible to an output of the model deployed in the receiver of the first device.

In another possible implementation of Manner 3, when the reference model is the second model, the first device trains the first model and a first adaptation layer based on the second model. For example, when the first device is a transmit device, the second device is a receive device, the first model is a model deployed in the transmitter of the first device, and the second model is a model deployed in the receiver of the second device, an adaptation training process is shown in FIG. 10B. The first device processes data #1 based on the first model to obtain data #2, and processes the data #2 by using the first adaptation layer to obtain data #3. The first device sends the data #3 to the second device. The second device processes the data #3 based on the second model to obtain data #4. A training objective of the adaptation training may be understood as making a small error between the data #4 and the data #1. Alternatively, a training objective may be understood as that, in the case of a same input, an output obtained through joint processing of the first model and the first adaptation layer is as close as possible to an output of the model deployed in the transmitter of the second device.

It can be seen that, according to the model alignment method described in FIG. 7 in this application, the data feature information of the first training dataset includes the data feature information of the second training dataset, and the first model and the second model that are obtained based on this have a degree of similarity in terms of feature representation. Further, in the model alignment process, compared with aligning models that do not have such similarity, this application aligns models having a degree of similarity, which helps improve a model alignment speed.

It may be understood that, to implement the foregoing functions, the foregoing device includes a corresponding hardware structure and/or software module for performing each function. A person skilled in the art should be easily aware that, with reference to units and algorithm steps in examples described in embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In embodiments of this application, the first device or the second device may be divided into functional modules based on the foregoing method examples. For example, each functional module may be obtained through division based on a corresponding function, or two or more functions may be integrated into one processing module. The integrated module may be implemented in a form of hardware, or may be implemented in a form of a software functional module. It should be noted that, in embodiments of this application, division into modules is an example, and is merely logical function division. In an actual implementation, another division manner may be used.

FIG. 11 is a diagram of a structure of a communication apparatus 1100 according to an embodiment of this application. The communication apparatus shown in FIG. 11 may be a first device, an apparatus in the first device, or an apparatus that can be used together with the first device. The communication apparatus shown in FIG. 11 may include a communication unit 1101 and a processing unit 1102. The communication apparatus shown in FIG. 11 may be a second device, an apparatus in the second device, or an apparatus that can be used together with the second device. The communication apparatus shown in FIG. 11 may include the communication unit 1101 and the processing unit 1102. Specifically, the processing unit 1102 is configured to process data. The data may be data received by the communication unit 1101, and the processed data may also be sent by the communication unit 1101. The communication unit 1101 may be understood as a transceiver unit, including a receiving module and/or a sending module. The receiving module is configured to perform a receiving action of the device (namely, the first device or the second device) in any embodiment in FIG. 4 or FIG. 7. The sending module is configured to perform a sending action of the device (namely, the first device or the second device) in any embodiment in FIG. 4 or FIG. 7.

In an implementation, when the communication apparatus 1100 is a first device, an apparatus in the first device (for example, a chip or a chip system in the first device), or an apparatus that can be used together with the first device, the communication unit 1101 is configured to: receive data feature information of a second local dataset from the second device, where the second local dataset is a dataset of the second device; and the processing unit 1102 is configured to determine a first training dataset based on the data feature information of the second local dataset and a first local dataset, where the first local dataset is a dataset of the first device, and data feature information of the first training dataset includes the data feature information of the second local dataset and data feature information of the first local dataset; and the processing unit 1102 is further configured to obtain a first model based on the first training dataset, where the first model is a model deployed on the first device.

In a possible implementation, the data feature information includes one or more of the following: data identification information, data distribution information, or data classification information, where the data identification information indicates data included in a dataset, the data distribution information indicates distribution of the data in the dataset, and the data classification information indicates classification of the data in the dataset.

In a possible implementation, the data distribution information includes one or more of cluster distribution information, probability distribution information, or model parameter information of a data generation model; and the data classification information includes one or more of geographic area information, signal-related information, device configuration information, quality-related information, classification center information, Doppler information, or delay spread information.

In a possible implementation, the processing unit 1102 is further configured to determine data feature information of a second dataset difference set from the data feature information of the second local dataset based on the data feature information of the first local dataset, where the data feature information of the second dataset difference set is data feature information not included in the first local dataset; the communication unit 1101 is further configured to send the data feature information of the second dataset difference set to the second device; and the communication unit 1101 is further configured to receive the second dataset difference set from the second device, where the first training dataset is a union of the second dataset difference set and the first local dataset.

In a possible implementation, the processing unit 1102 is further configured to determine data feature information of a first dataset difference set from the first local dataset based on the data feature information of the second local dataset, where the data feature information of the first dataset difference set is data feature information not included in the second local dataset; and the communication unit 1101 is further configured to send the first dataset difference set to the second device.

In a possible implementation, the processing unit 1102 is further configured to align the first model with a second model, where the second model is a model deployed on the second device, the second model is obtained based on a second training dataset, and the data feature information of the first training dataset includes data feature information of the second training dataset.

In a possible implementation, the data feature information of the second training dataset is the same as the data feature information of the first training dataset.

In a possible implementation, the processing unit 1102 is further configured to determine data feature information of a first dataset difference set from the first local dataset based on the data feature information of the second local dataset, where the data feature information of the first dataset difference set is data feature information not included in the second local dataset; and the communication unit 1101 is further configured to send the first dataset difference set to the second device.

In a possible implementation, the processing unit 1102 is further configured to determine a reference model based on a size of the first training dataset and a size of the second training dataset, where the reference model is the first model or the second model; and the processing unit 1102 is further configured to align the first model with the second model based on the reference model.

In a possible implementation, the data feature information included in the first training dataset further includes data feature information of a third training dataset, the third training dataset is used to train a third model, and the third model is a model deployed on a third device.

For more detailed descriptions of the communication unit 1101 and the processing unit 1102, refer to related descriptions of the first device in the method embodiment shown in FIG. 4 or FIG. 7.

In an implementation, the communication apparatus 1100 is a second device, an apparatus in the second device, or an apparatus that can be used together with the second device.

The communication unit 1101 is configured to send data feature information of a second local dataset to a first device, where the second local dataset is a dataset of the second device.

In a possible implementation, the data feature information includes one or more of the following: data identification information, data distribution information, or data classification information, where the data identification information indicates data included in a dataset, the data distribution information indicates distribution of the data in the dataset, and the data classification information indicates classification of the data in the dataset.

In a possible implementation, the data distribution information includes one or more of cluster distribution information, probability distribution information, or model parameter information of a data generation model; and the data classification information includes one or more of geographic area information, signal-related information, device configuration information, quality-related information, or classification center information.

In a possible implementation, the communication unit 1101 is further configured to receive data feature information of a second dataset difference set from the first device, where the data feature information of the second dataset difference set is data feature information included in the second local dataset but not included in a first local dataset, and the first local dataset is a dataset of the first device. The communication unit 1101 is further configured to send the second dataset difference set to the first device based on the data feature information of the second dataset difference set.

In a possible implementation, the processing unit 1102 is further configured to align a first model with a second model, where the second model is a model deployed on the second device, the second model is obtained based on a second training dataset, and data feature information of a first training dataset includes data feature information of the second training dataset.

In a possible implementation, the data feature information of the second training dataset is the same as the data feature information of the first training dataset.

In a possible implementation, the communication unit 1101 is further configured to receive a first dataset difference set from the first device, where data feature information of the first dataset difference set is data feature information included in the first local dataset but not included in the second local dataset, and the second training dataset is a union of the first dataset difference set and the second local dataset.

In a possible implementation, the processing unit 1102 is further configured to determine a reference model based on a size of the first training dataset and a size of the second training dataset, where the reference model is the first model or the second model. The processing unit 1102 is further configured to align the first model with the second model based on the reference model.

In a possible implementation, the data feature information included in the first training dataset further includes data feature information of a third training dataset, the third training dataset is used to train a third model, and the third model is a model deployed on a third device.

For more detailed descriptions of the communication unit 1101 and the processing unit 1102, refer to related descriptions of the second device in the method embodiment shown in FIG. 4 or FIG. 7.

In a possible implementation, when the communication apparatus 1100 is a chip, the communication unit 1101 may be a communication interface, a pin, a circuit, or the like. The communication interface may be configured to input to-be-processed data to a processor, and may output a processing result of the processor to the outside. During specific implementation, the communication interface may be a general purpose input/output (GPIO) interface, and may be connected to a plurality of peripheral devices (for example, a display (LCD), a camera, a radio frequency (RF) module, and an antenna). The communication interface is connected to the processor through a bus.

The processing unit 1102 may be a processor. The processor may execute computer-executable instructions stored in a storage module, to enable the chip to perform the method in the embodiment shown in FIG. 4 or FIG. 7. Further, the processor may include a controller, an arithmetic unit, and a register. For example, the controller is mainly responsible for instruction decoding, and transmitting a control signal for an operation corresponding to the instructions. The arithmetic unit is mainly responsible for performing a fixed-point or floating-point arithmetic operation, a shift operation, a logic operation, and the like, and may also perform an address operation and address translation. The register is mainly responsible for storing a quantity of register operations, intermediate operation results, and the like that are temporarily stored during instruction execution. During specific implementation, a hardware architecture of the processor may be an application-specific integrated circuit (ASIC) architecture, a microprocessor without interlocked piped stages architecture (MIPS), an advanced reduced instruction set computing machines (advanced RISC machines, ARM) architecture, a second processor (network processor, NP) architecture, or the like. The processor may be a single-core processor or a multi-core processor. The storage module may be a storage module inside the chip, for example, a register or a cache. Alternatively, the storage module may be a storage module located outside the chip, for example, a read-only memory (ROM), another type of static storage device that can store static information and instructions, or a random access memory (RAM).

It should be noted that functions respectively corresponding to the processor and the interface may be implemented by using a hardware design, or may be implemented by using a software design, or may be implemented by using a combination of software and hardware. This is not limited herein.

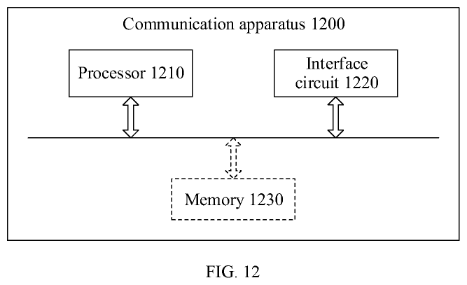

FIG. 12 is a diagram of a structure of another communication apparatus according to an embodiment of this application. It may be understood that the communication apparatus 1200 includes means in necessary forms such as modules, units, elements, circuits, or interfaces, which are appropriately configured together to perform the solution. The communication apparatus 1200 may be the foregoing first device or second device, or may be a component (for example, a chip) in these devices, to implement the method described in the foregoing method embodiments.

In a possible design, as shown in FIG. 12, the communication apparatus 1200 includes a processor 1210 and an interface circuit 1220. The processor 1210 and the interface circuit 1220 are coupled to each other.

Optionally, the communication apparatus 1200 may include one or more processors 1210. The processor 1210 may be a general-purpose processor, a dedicated processor, or the like. For example, the processor may be a baseband processor or a central processing unit. The baseband processor may be configured to process a communication protocol and communication data. The central processing unit may be configured to control the communication apparatus (for example, a terminal device, a network device, or a chip), to execute a software program and process data of the software program.

It may be understood that the interface circuit 1220 may be a transceiver or an input/output interface. When the communication apparatus 1200 is the first device or the second device, the interface circuit 1220 is a transceiver, and includes a transmitter and/or a receiver. The transmitter may be referred to as a sending unit, a transmitter machine, a transmitter circuit, or the like, and is configured to implement a sending function. The receiver may be referred to as a receiving unit, a receiver machine, a receiver circuit, or the like, and is configured to implement a receiving function. When the communication apparatus 1200 is a chip in the first device or the second device, the interface circuit 1220 is an input/output interface of the chip. Optionally, the communication apparatus 1200 may further include an antenna (not shown in the figure). The interface circuit 1220 may also be sometimes referred to as a transceiver unit, a transceiver machine, a transceiver circuit, a transceiver, or the like, and is configured to implement a transceiver function of the communication apparatus through the antenna.

Optionally, the communication apparatus 1200 may further include a memory 1230, configured to store instructions executed by the processor 1210, store input data required by the processor 1210 to run instructions, or store data generated after the processor 1210 runs instructions. Optionally, the processor 1210 and the memory 1230 may be disposed separately, or may be integrated together.

When the communication apparatus 1200 is configured to implement the method shown in FIG. 4 or FIG. 7, the processor 1210 is configured to implement a function of the processing unit 1102, and the interface circuit 1220 is configured to implement a function of the communication unit 1101.

When the communication apparatus is a chip used in the first device, the chip in the terminal implements a function of the first device in the foregoing method embodiments. The chip in the first device receiving information from the second device may be understood as that the information is first received by other modules (for example, a radio frequency module or an antenna) in the first device, and then sent by these modules to the chip in the first device. The chip in the first device sending information to the second device may be understood as that the information is first sent to other modules (for example, a radio frequency module or an antenna) in the first device, and then sent by these modules to the second device.

When the communication apparatus is a chip used in the second device, the chip in the second device implements a function of the second device in the foregoing method embodiments. The chip in the second device receiving information from the first device may be understood as that the information is first received by other modules (for example, a radio frequency module or an antenna) in the second device, and then sent by these modules to the chip in the second device. The chip in the second device sending information to the first device may be understood as that the information is sent to other modules (for example, a radio frequency module or an antenna) in the second device, and then sent by these modules to the first device.

An embodiment of this application further provides a computer-readable storage medium. The computer-readable storage medium stores computer instructions. When the computer instructions are executed, a computer is enabled to perform the method in the embodiment in FIG. 4 or FIG. 7.

An embodiment of this application further provides a computer program product. The computer program product includes computer program code. When the computer program code is run by a computer, the computer is enabled to perform the method in the embodiment in FIG. 4 or FIG. 7.

In this application, an entity A sending information to an entity B may be that A directly sends the information to B, or may be that A indirectly sends the information to B via another entity. Similarly, the entity B receiving information from the entity A may be that the entity B directly receives the information sent by the entity A, or may be that the entity B indirectly receives the information sent by the entity A via another entity. The entity A and the entity B herein each may be a RAN node or a terminal, or may be a module in the RAN node or the terminal. Information sending and receiving may be information exchange between a RAN node and a terminal, for example, information exchange between a base station and a terminal. Information sending and receiving may alternatively be information exchange between two RAN nodes, for example, information exchange between a CU and a DU. Information sending and receiving may alternatively be information exchange between different modules in an apparatus, for example, information exchange between a chip in a terminal and another module in the terminal, or information exchange between a chip in a base station and another module in the base station.

It should be understood that the processor mentioned in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor, any regular processor, or the like.

The method steps in embodiments of this application may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk drive, a removable hard disk, a CD-ROM, or any other form of storage medium well-known in the art. For example, a storage medium is coupled to a processor, so that the processor can read information from the storage medium and write information into the storage medium. The storage medium may alternatively be a component of the processor. The processor and the storage medium may be disposed in an ASIC. In addition, the ASIC may be located in a base station or a terminal. Certainly, the processor and the storage medium may exist in a base station or terminal as discrete components.

All or a part of the foregoing embodiments may be implemented by software, hardware, firmware, or any combination thereof. When software is used to implement the embodiments, all or a part of the embodiments may be implemented in the form of a computer program product. The computer program product includes one or more computer programs or instructions. When the computer programs or the instructions are loaded and executed on a computer, the procedures or functions in embodiments of this application are all or partially performed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk drive, or a magnetic tape; or may be an optical medium, for example, a digital video disc; or may be a semiconductor medium, for example, a solid-state drive. The computer-readable storage medium may be a volatile or non-volatile storage medium, or may include both the volatile storage medium and the non-volatile storage medium.

“Embodiments” mentioned in this specification mean that specific features, structures, or characteristics described in combination with embodiments may be included in at least one embodiment of this application. The phrase shown in various locations in the specification may not necessarily refer to a same embodiment, and is not an independent or optional embodiment exclusive from another embodiment. It is explicitly and implicitly understood by a person skilled in the art that embodiments described in the specification may be combined with another embodiment.

In embodiments of this application, unless otherwise stated or there is a logic conflict, terms and/or descriptions between different embodiments are consistent and may be mutually referenced, and technical features in different embodiments may be combined into a new embodiment based on an internal logical relationship thereof.

In this application, at least one means one or more, and a plurality of means two or more. “And/or” describes an association relationship between associated objects and indicates that three relationships may exist. For example, A and/or B may indicate the following three cases: Only A exists, both A and B exist, and only B exists, where A and B may be singular or plural. In the text descriptions of this application, the character “/” represents an “or” relationship between the associated objects. In a formula in this application, the character “/” represents a “division” relationship between the associated objects. “Including at least one of A, B, and C” may represent: including A; including B; including C; including A and B; including A and C; including B and C; and including A, B, and C.

The terms “first”, “second”, and the like in the specification, claims, and accompanying drawings of this application are intended to distinguish between different objects, but are not intended to describe a specific sequence. In addition, the terms “including” and “having” and any other variants thereof are intended to cover a non-exclusive inclusion. For example, a process, a method, a system, a product, or a device that includes a series of operations or units is not limited to the enumerated operations or units, but optionally further includes an unenumerated operation or unit, or optionally further includes another inherent operation or unit of the process, the method, the product, or the device.

“Sending” and “receiving” in this application indicate a signal transmission direction. For example, “sending information to XX” may be understood as that a destination end of the information is XX, and may include direct sending through an air interface, or include indirect sending through an air interface by another unit or module. “Receiving information from YY” may be understood as that a source end of the information is YY, and may include direct receiving from YY through an air interface, or may include indirect receiving from YY through an air interface from another unit or module. “Sending” may also be understood as “outputting” of a chip interface, and “receiving” may also be understood as “inputting” of the chip interface. In other words, sending and receiving may be performed between devices, for example, between a network device and a terminal device; or may be performed inside a device, for example, sending or receiving between components, modules, chips, software modules, or hardware modules inside the device through a bus, a cable, or an interface. It may be understood that necessary processing such as encoding and modulation may be performed on the information during transmission of information between the source end and the destination end, but the destination end can understand valid information from the source end. Similar expressions in this application may be understood similarly. Details are not described again.

In this application, “indicate” may include a direct indication and an indirect indication, or may include an explicit indication and an implicit indication. Information indicated by a piece of information (for example, the following indication information) is referred to as to-be-indicated information. During specific implementation, the to-be-indicated information may be indicated in a plurality of manners, for example, but not limited to, directly indicating the to-be-indicated information, for example, indicating the to-be-indicated information, an index of the to-be-indicated information, or the like. Alternatively, the to-be-indicated information may be indirectly indicated by indicating other information. There is an association relationship between the other information and the to-be-indicated information. Alternatively, only a part of the to-be-indicated information may be indicated, and the remaining part of the to-be-indicated information is known or pre-agreed on. For example, specific information may be indicated by an arrangement sequence of pieces of information that is pre-agreed on (for example, predefined in a protocol), to reduce indication overheads to some extent. A specific indication manner is not limited in this application. It may be understood that, for a sender of the indication information, the indication information may indicate to-be-indicated information, and for a receiver of the indication information, the indication information may be used to determine to-be-indicated information.

It may be understood that various numerical designations in embodiments of this application are merely used for differentiation for ease of description, and are not used to limit the scope of embodiments of this application. Sequence numbers of the foregoing processes do not mean an execution sequence, and the execution sequence of the processes should be determined based on functions and internal logic of the processes.

1. A model training method, wherein the method comprises:
receiving data feature information of a second local dataset from a second device, wherein the second local dataset is a dataset of the second device;
determining a first training dataset based on the data feature information of the second local dataset and a first local dataset, wherein the first local dataset is a dataset of a first device, and data feature information of the first training dataset comprises the data feature information of the second local dataset and data feature information of the first local dataset; and
obtaining a first model based on the first training dataset, wherein the first model is a model deployed on the first device.

2. The method according to claim 1, wherein determining the first training dataset based on the data feature information of the second local dataset and the first local dataset comprises:
determining data feature information of a dataset difference set from the data feature information of the second local dataset based on the data feature information of the first local dataset, wherein the data feature information of the dataset difference set is data feature information not comprised in the first local dataset;
sending the data feature information of the dataset difference set to the second device; and
receiving the dataset difference set from the second device, wherein the first training dataset is a union of the dataset difference set and the first local dataset.

3. The method according to claim 1, wherein the method further comprises:
aligning the first model with a second model, wherein the second model is a model deployed on the second device, the second model is obtained based on a second training dataset, and the data feature information of the first training dataset comprises data feature information of the second training dataset; and
wherein the second training dataset comprises the data feature information of the second local dataset, or the second training dataset comprises the data feature information of the second local dataset and the data feature information of the first local dataset.

4. The method according to claim 3, wherein before aligning the first model with the second model, the method further comprises:
determining data feature information of a dataset difference set from the first local dataset based on the data feature information of the second local dataset, wherein the data feature information of the dataset difference set is data feature information not comprised in the second local dataset; and
sending the dataset difference set to the second device, wherein the second training dataset is a union of the dataset difference set and the second local dataset.

5. The method according to claim 3, wherein aligning the first model with the second model comprises:
determining a reference model based on a size of the first training dataset and a size of the second training dataset, wherein the reference model is the first model or the second model; and
aligning the first model with the second model based on the reference model.

6. The method according to claim 3, wherein the data feature information of the first training dataset further comprises data feature information of a third training dataset, the third training dataset is used to train a third model, and the third model is a model deployed on a third device.

7. The method according to claim 1, wherein:
data feature information of a dataset comprises one or more of data identification information, data distribution information, or data classification information; and
the data identification information indicates data comprised in the dataset, the data distribution information indicates distribution of the data in the dataset, and the data classification information indicates classification of the data in the dataset.

8. A data transmission method, wherein the method comprises:
sending data feature information of a second local dataset to a first device, wherein the second local dataset is a dataset of a second device.

9. The method according to claim 8, wherein the method further comprises:
receiving data feature information of a dataset difference set from the first device, wherein the data feature information of the dataset difference set is data feature information comprised in the second local dataset but not comprised in a first local dataset, and the first local dataset is a dataset of the first device; and
sending the dataset difference set to the first device based on the data feature information of the dataset difference set.

10. The method according to claim 9, wherein the method further comprises:
aligning a first model with a second model, wherein the second model is a model deployed on the second device, the second model is obtained based on a second training dataset, and data feature information of a first training dataset comprises data feature information of the second training dataset; and
wherein the second training dataset comprises the data feature information of the second local dataset, or the second training dataset comprises the data feature information of the second local dataset and the data feature information of the first local dataset.

11. The method according to claim 10, wherein before aligning the first model with the second model, the method further comprises:
receiving a dataset difference set from the first device, wherein data feature information of the dataset difference set is data feature information comprised in the first local dataset but not comprised in the second local dataset, and the second training dataset is a union of the dataset difference set and the second local dataset.

12. The method according to claim 10, wherein aligning the first model with the second model comprises:
determining a reference model based on a size of the first training dataset and a size of the second training dataset, wherein the reference model is the first model or the second model; and
aligning the first model with the second model based on the reference model.

13. The method according to claim 10, wherein the data feature information of the first training dataset further comprises data feature information of a third training dataset, the third training dataset is used to train a third model, and the third model is a model deployed on a third device.

14. The method according to claim 8, wherein:
the data feature information of the second local dataset comprises one or more of data identification information, data distribution information, or data classification information; and
the data identification information indicates data comprised in the second local dataset, the data distribution information indicates distribution of the data in the second local dataset, and the data classification information indicates classification of the data in the second local dataset.

15. The method according to claim 14, wherein:
the data distribution information comprises one or more of cluster distribution information, probability distribution information, or model parameter information of a data generation model; and
the data classification information comprises one or more of geographic area information, signal-related information, device configuration information, quality-related information, or classification center information.

16. A communication apparatus, comprising:
at least one processor; and
at least one memory coupled to the at least one processor and storing programming instructions for execution by the at least one processor to enable the communication apparatus to perform operations comprising:
receiving data feature information of a second local dataset from a second device, wherein the second local dataset is a dataset of the second device;
determining a first training dataset based on the data feature information of the second local dataset and a first local dataset, wherein the first local dataset is a dataset of a first device, and data feature information of the first training dataset comprises the data feature information of the second local dataset and data feature information of the first local dataset; and
obtaining a first model based on the first training dataset, wherein the first model is a model deployed on the first device.

17. The apparatus according to claim 16, wherein determining the first training dataset based on the data feature information of the second local dataset and the first local dataset comprises:
determining data feature information of a dataset difference set from the data feature information of the second local dataset based on the data feature information of the first local dataset, wherein the data feature information of the dataset difference set is data feature information not comprised in the first local dataset;
sending the data feature information of the dataset difference set to the second device; and
receiving the dataset difference set from the second device, wherein the first training dataset is a union of the dataset difference set and the first local dataset.

18. The apparatus according to claim 17, wherein the operations further comprise:
aligning the first model with a second model, wherein the second model is a model deployed on the second device, the second model is obtained based on a second training dataset, and the data feature information of the first training dataset comprises data feature information of the second training dataset; and
wherein the second training dataset comprises the data feature information of the second local dataset, or the second training dataset comprises the data feature information of the second local dataset and the data feature information of the first local dataset.

19. The apparatus according to claim 18, wherein before aligning the first model with the second model, the operations further comprise:
determining data feature information of a dataset difference set from the first local dataset based on the data feature information of the second local dataset, wherein the data feature information of the dataset difference set is data feature information not comprised in the second local dataset; and
sending the dataset difference set to the second device, wherein the second training dataset is a union of the dataset difference set and the second local dataset.

20. The apparatus according to claim 18, wherein aligning the first model with the second model comprises:
determining a reference model based on a size of the first training dataset and a size of the second training dataset, wherein the reference model is the first model or the second model; and
aligning the first model with the second model based on the reference model.

21. The apparatus according to claim 18, wherein the data feature information of the first training dataset further comprises data feature information of a third training dataset, the third training dataset is used to train a third model, and the third model is a model deployed on a third device.

22. The apparatus according to claim 16, wherein:
data feature information of a dataset comprises one or more of data identification information, data distribution information, or data classification information; and
the data identification information indicates data comprised in the dataset, the data distribution information indicates distribution of the data in the dataset, and the data classification information indicates classification of the data in the dataset.

23. A communication apparatus, comprising:
at least one processor; and
at least one memory coupled to the at least one processor and storing programming instructions for execution by the at least one processor to enable the communication apparatus to perform operations comprising:
sending data feature information of a second local dataset to a first device, wherein the second local dataset is a dataset of a second device.

24. The apparatus according to claim 23, wherein the operations further comprise:
receiving data feature information of a dataset difference set from the first device, wherein the data feature information of the dataset difference set is data feature information comprised in the second local dataset but not comprised in a first local dataset, and the first local dataset is a dataset of the first device; and
sending the dataset difference set to the first device based on the data feature information of the dataset difference set.

25. The apparatus according to claim 24, wherein the operations further comprise:
aligning a first model with a second model, wherein the second model is a model deployed on the second device, the second model is obtained based on a second training dataset, and data feature information of a first training dataset comprises data feature information of the second training dataset; and
wherein the second training dataset comprises the data feature information of the second local dataset, or the second training dataset comprises the data feature information of the second local dataset and the data feature information of the first local dataset.

26. The apparatus according to claim 25, wherein before aligning the first model with the second model, the operations further comprise:
receiving a dataset difference set from the first device, wherein data feature information of the dataset difference set is data feature information comprised in the first local dataset but not comprised in the second local dataset, and the second training dataset is a union of the dataset difference set and the second local dataset.

27. The apparatus according to claim 25, wherein aligning the first model with the second model comprises:
determining a reference model based on a size of the first training dataset and a size of the second training dataset, wherein the reference model is the first model or the second model; and
aligning the first model with the second model based on the reference model.

28. The apparatus according to claim 25, wherein the data feature information of the first training dataset further comprises data feature information of a third training dataset, the third training dataset is used to train a third model, and the third model is a model deployed on a third device.

29. The apparatus according to claim 23, wherein:
data feature information of the second local dataset comprises one or more of data identification information, data distribution information, or data classification information; and
the data identification information indicates data comprised in the second local dataset, the data distribution information indicates distribution of the data in the second local dataset, and the data classification information indicates classification of the data in the second local dataset.

30. The apparatus according to claim 29, wherein:
the data distribution information comprises one or more of cluster distribution information, probability distribution information, or model parameter information of a data generation model; and
the data classification information comprises one or more of geographic area information, signal-related information, device configuration information, quality-related information, or classification center information.
